(19) United States
(12) Patent Application Publication
(10) Pub. No.: US 2007/0282035 A1
(43) Pub. Date: Dec. 6, 2007

(54) Composition for injection moulding, part produced from the composition and method for production of the composition

(75) Inventors: Brigitte Ohl, Saint Martin d'Uriage (FR); Joan Aymami, Grenoble (FR)

Correspondence Address: STEPTOE & JOHNSON LLP, 1330 CONNECTICUT AVENUE, N.W., WASHINGTON, DC, 20036, US

(73) Assignee: SCHNEIDER ELECTRIC INDUSTRIES SAS, Rueil Malmaison (FR)

(21) Appl. No.: 11/797,454

(22) Filed: May 3, 2007

(30) Foreign Application Priority Data
May 30, 2006 (FR) 06 04814

(51) Int. Cl. C08K 7/00; B60C 1/00

(52) U.S. Cl. 523/220; 524/492

(57) ABSTRACT

A composite composition for injection moulding comprising:
an organic matrix,
between 5 and 15% in weight of reinforcing fibers, and
solid particles comprising more than 5% in weight of beads and fire-resistant mineral particles 50% in weight whereof present a distribution function of equivalent diameters comprising at least two modes.
   A method for producing 100 parts in weight of the composition comprising:
preparation of an organic matrix,
adding and mixing of 5 to 15 parts in weight of reinforcing fibers, and
adding and mixing of solid particles comprising fire-resistant mineral particles and more than 5 parts in weight of beads.
   A part obtained by injection and by moulding of the composition.

### BACKGROUND OF THE INVENTION

The invention relates to a composite composition for injection moulding comprising:
from 15 to 50% weight of an organic matrix comprising a thermosetting resin,
reinforcing fibers, and
solid particles containing fire-resistant mineral particles.

The invention also relates to a method for production of 100 parts in weight of a composition for injection moulding comprising:
preparation of at least a part of an organic matrix by mixing compounds containing a thermosetting resin,
adding and mixing reinforcing fibers, and
adding and mixing solid particles containing fire-resistant mineral particles.

The invention also finally relates to a part obtained by injection moulding of the composite composition described above.

### STATE OF THE ART

Thermosetting compositions used for injection moulding of parts with relatively small dimensions, in particular cases for housing electric equipment, for example circuit breakers, are generally of the composite type.

It is known to use composite compositions containing an organic matrix, reinforcing fibers and fire-resistant mineral particles for injection moulding.

French Patent application N^{o} 2 728 908 describes good flame-resistant construction elements essentially constituted by a hardened non-saturated polyester resin reinforced by glass fibers and with an aluminium oxide (alumina) trihydrate charge.

When this type of composition is implemented for injection moulding of parts with relatively small dimensions, the distribution of the reinforcing fibers in these parts is generally rather inhomogeneous. Moreover, the orientation of the reinforcing fibers in these parts is generally far from being isotropic.

### SUMMARY OF THE INVENTION

The object of the invention is to achieve a composition enabling the shortcomings of the prior art to be overcome.

A composite composition according to the invention comprises:
from 15 to 50% weight of an organic matrix comprising a thermosetting resin,
reinforcing fibers, and
solid particles containing fire-resistant mineral particles,
   wherein the quantity of reinforcing fibers is comprised between 5 and 15% in weight of said composition, wherein at least a portion of the solid particles greater than 5% in weight of said composition comprises beads, and wherein at least 50% in weight of the fire-resistant mineral particles present a distribution function of the equivalent diameters comprising at least two modes.

Preferably, the beads have a form factor of less than 2. Advantageously, the beads are substantially spherical-shaped. Preferably, the beads are made of glass.

According to a preferred embodiment of the invention, a reinforcing fiber comprises a plurality of filaments.

Preferably, the beads have a diameter comprised between 0.3 and 5 times the mean diameter of the filaments.

According to one embodiment, at least 90% in weight of the solid particles present an equivalent diameter comprised between 0.05 and 5 times the mean diameter of the filaments of the reinforcing fibers. Preferably, the median of the cumulative granulometric distribution function corresponding to the fiftieth percentile in weight of the solid particles is comprised within 0.2 and 2.0 times the mean diameter of the filaments of the reinforcing fibers. Advantageously, at least 50% in weight of the solid particles present a distribution function of the equivalent diameters comprising at least three modes.

According to another embodiment, at least 90% in weight of the fire-resistant mineral particles present a mean equivalent diameter comprised between 0.05 and 5 times the mean diameter of the filaments of the reinforcing fibers. Preferably, the median of the cumulative granulometric distribution function corresponding to the fiftieth percentile in weight of the fire-resistant mineral particles is comprised within 0.1 and 2.0 times the mean diameter of the filaments of the reinforcing fibers.

Preferably, the fire-resistant mineral particles are essentially formed by hydrated aluminas.

Preferably, the fire-resistant mineral particles have different shapes.

Preferably, the organic matrix contains a thermoplastic additive.

The invention also relates to a method for production of 100 parts in weight of a composition for injection moulding comprising:
preparation of at least a part of an organic matrix by mixing compounds containing a thermosetting resin,
adding and mixing reinforcing fibers, and
adding and mixing solid particles comprising fire-resistant mineral particles,
   wherein the quantity of added and mixed reinforcing fibers is comprised between 5 and 15 parts in weight of said composition, wherein a portion of the added and mixed solid particles comprises at least 5 parts in weight of beads, and wherein at least 50% in weight of the fire-resistant mineral particles present a distribution function of the equivalent diameters comprising at least two modes.

Preferably, adding and mixing of the beads and the reinforcing fibers are performed substantially at the same time.

Preferably, another part of the organic matrix comprising a coupling size agent is added substantially together with the fire-resistant mineral particles.

Advantageously, adding and mixing of the beads are performed keeping the temperature of the composition at a substantially constant value.

The invention also relates to a part obtained by injection moulding of a composition, said composition being a composite composition as described above, the shape of the part being defined by the shape of the mould in which said composition is injected.

### BRIEF DESCRIPTION OF THE DRAWINGS

Other advantages and features will become more clearly apparent from the following description of particular embodiments of the invention, given as non-restrictive examples only, and represented in the accompanying figures.

FIG. 1 represents, for example purposes, a distribution function of the equivalent diameters of the fire-resistant mineral particles of the composite composition according to the invention.

FIG. 2 schematically represents fire-resistant mineral particles having different shapes in an injection-moulded composition.

FIG. 3 schematically represents an example of the method for production of a composite composition according to the invention.

### DETAILED DESCRIPTION OF PREFERRED EMBODIMENTS OF THE INVENTION

The organic matrix MO of the composite composition can comprise from 65 to 80% in weight, preferably from 72 to 78% in weight of a thermosetting matrix TDG. What is meant by thermosetting matrix is a polymer-based material from which a part can be achieved by hot working, this material being the seat of irreversible chemical reactions at the outcome of which the final shape is established. The base of the thermosetting matrix TDG can be formed by three-dimensional macromolecular compounds obtained by chemical transformation, these compounds being able to be thermally hardened or stiffened. For example, the macromolecular compounds of the thermosetting matrix TDG can comprise or essentially be constituted by polyurethanes, epoxides, non-saturated polyesters, ester vinyls, and/or phenolics. The macromolecular compounds of the thermosetting matrix TDG can also be hybrid solutions combining compounds of different chemical natures. Among the non-saturated polyesters, it is possible to use orthophtalic, maleic, maleophtalic, isophtalic, ester vinyl, or dicyclopentadiene resins.

Preferably, the thermosetting matrix is of generic type, i.e. the chemical reactions related to implementation of this material are of known type, in particular radical copolymerization reactions of a monomer, in general styrene, with the double bonds of a prepolymer. The prepolymer can be prepared in an initial step by polyesterification. In the case where the macromolecular compounds of the thermosetting matrix TDG are non-saturated polyesters, the latter are generally in solution in styrene acting as reticulation agent at the time copolymerization takes place. In the case of radical copolymerization of styrene with the prepolymer, a compound is obtained having a three-dimensional structure of polyester chains linked by small polystyrene chains.

The organic matrix MO of the composite composition can comprise from 3 to 25% in weight, preferably 5 to 15% in weight of a thermoplastic additive TPS. Generally, the thermoplastic additive TPS acts in synergy with the thermosetting resin so as to reduce the intrinsic shrinkage caused by polymerization of the thermosetting network when reticulation takes place. The thermoplastic additives TPS can be chosen from polystyrene, polyethylene, polyvinyl acetate, polyacrylate, polymethyl methacrylate, and/or thermoplastic polyesters.

Preferably, the thermoplastic additive TPS is of specific type, i.e. it enables suitable specific chemical reactions to be implemented to limit the intrinsic shrinkage induced by the reticulation reactions of the thermosetting matrix TDG.

The organic matrix MO of the composite composition can comprise from 0.005 to 0.2% in weight, preferably from 0.005 to 0.15% in weight, of a reaction-initiating additive AA. Generally, the reaction-initiating additive AA initiates chemical reactions of the thermosetting matrix TDG, in particular reticulation reactions. The reaction-initiating additive AA can act by decomposing and producing free radicals at given temperatures. This production of free radicals is generally performed by a radical mechanism, the reticulation reaction then propagating by itself. The reaction-initiating additive AA can be any type of reaction-initiating additive known to those skilled in the trade, such as alkyl hydroperoxides, dialkyl peroxides, peresters, diacyl peroxides, and/or peroxides derived from ketones. For example, the reaction-initiating additive AA can be tertiobutyl perbenzoate, tertiobutyl hydroperoxide, cumene hydroperoxide, ditertiobutyl peroxide and/or dicumyl leperoxide.

The organic matrix MO of the composite composition can also comprise from 0.0001 to 0.01% in weight, preferably from 0.0001 to 0.002% in weight, of an inhibiting additive SAI delaying reticulation. This additive can comprise one or more additives whose role is to inhibit reticulation reactions of the thermosetting matrix TDG. This additive can be any type of inhibiting additive known to those skilled in the art, i.e. any additive enabling the conservation time of the parts injection moulded from the composition of the invention to be increased. This additive can also be any additive making the parts moulded by injection compatible with an industrial use. The inhibiting additive SAI generally enables initiation of the reticulation reactions of the thermosetting matrix TDG to be delayed for a given lapse of time. When this time period has elapsed, the reticulation reaction kinetics revert to normal.

The inhibiting additive SAI can be chosen from the following compounds used alone or in a mixture: hydroquinone, monotertiobutylhydroquinone, toluhydroquinone, ditertiobutyl-2,5-hydroquinone, benzoquinone, quinhydrone, parabenzoquinone, paratertiobutylcatechol, or ditertiobutyl-2,6-paracresol.

The organic matrix MO of the composite composition can also comprise from 0.01 to 0.2% in weight, preferably from 0.02 to 0.1% in weight, of a stripping agent AD. The stripping agent AD generally enables a part to be removed from the mould more easily by limiting its adhesion to the walls of the mould. The stripping agent AD thus enables the surface condition of the injection moulded part to be improved. The stripping agent can contain a stearic acid and/or stearic acid salts. In particular, the stripping agent AD can contain calcium stearate, zinc stearate and/or magnesium stearate.

The composite composition comprises from 15 to 50% in weight of the organic matrix. Preferably, the composite composition comprises from 26 to 40% in weight of the organic matrix.

In addition to the organic matrix MO, the composite composition comprises from 5 to 15% in weight, preferably from 7 to 14% in weight, of reinforcing fibers RF. A reinforcing fiber generally comprises a plurality of filaments. The fibers and filaments can present a mean length comprised between 3 and 50 mm, preferably comprised between 3 and 25 mm. The mean diameter of the filaments can be comprised between 1 and 50 μm, preferably comprised between 5 and 25 μm. The fibers are generally mixed with the organic matrix, which has the effect of reducing their length and of bonding them tightly with all the compounds contained in the composition. The composite composition obtained is thereby homogenized.

The reinforcing fibers RF can be any fibers known to those skilled in the art, coming for example in the form of cut wires. Different types of materials can be used such as for example carbon fibers, polyethylene terephtalate aramide® fibers, natural fibers of vegetal or mineral origin, or glass fibers of different types in particular of E type or S2 type.

In addition to the organic matrix MO and the reinforcing fibers RF, the composite composition can comprise from 20 to 70% in weight, preferably from 40 to 60% in weight, of solid particles.

The solid particles can comprise from 50 to 90% in weight, preferably from 70 to 90% in weight, of fire-resistant mineral particles CMP. These fire-resistant particles CMP particularly enable the fire behaviour of the moulded parts obtained from the composite composition to be improved. The fire-resistant particles are generally hydrated mineral particles in natural state. Preferably, the fire-resistant particles essentially comprise hydrated aluminas, for example tri-hydrated aluminas. The latter generally enable a large quantity of water to be released spontaneously when the temperature reaches 280 to 300° C.

According to one feature of the invention, at least a portion of the solid particles is formed by beads CMSE, the mass quantity of these beads being greater than 5% in weight of the composite composition. Preferably, the composite composition comprises from 5 to 15% in weight of beads CMSE. Advantageously, the mass quantity of beads CMSE is comprised between 0.25 and 1.2 times the mass quantity of reinforcing fibers (RF). Generally, the beads CMSE are manufactured from a mineral material the purity and nature whereof are compatible with the other compounds of the composite composition. Preferably, the beads CMSE are made of glass. The beads CMSE can present a treated surface so as to give them suitable interfacial properties.

Preferably, the beads CMSE have a form factor of less than 2. Advantageously, the form factor is less than 1.3, or substantially equal to 1. The form factor can be determined by measuring the ratio of the mean length over the apparent mean diameter. Measurement of the form factor can be performed by visualization with a scanning electron microscope. In this case, the form factor is determined by image analysis.

The beads CMSE preferably have a diameter comprised between 3 and 100 μm. The beads CMSE can also advantageously have a diameter comprised between 0.3 and 5 times the mean diameter of the filaments of the reinforcing fibers.

The use of beads CMSE in particular enables the formation of aggregates to be limited and the fluidity and homogeneity of the composite composition to be improved when the latter is implemented. The rheological behaviour of this composition is thereby improved. This results in a lower pressure and lesser abrasion in the injection and moulding equipment, and fosters flow of the composite composition in this equipment. The non-angular shape of these beads contributes to improving the distribution of forces within the moulded part, enabling more homogeneous mechanical and electrical stress fields to be obtained. The mechanical and dielectric durability of the moulded part is thereby increased and the impact resistance is improved. Likewise, the wear of the moulds is lessened, which results in a reduction of production costs. Moreover, the rheology of the composition is improved and reproducible, which greatly increases the mechanical stress resistance while preserving the fire resistance.

The granulometry of the solid particles of the composition has an impact on the properties of the parts made from such a composition, in particular on the mechanical strength and dielectric withstand of these parts. This granulometry can be determined either with respect to the fire-resistant mineral particles CMP or with respect to all the solid particles of the composition, i.e. an assembly including the fire-resistant mineral particles CMP and the beads CMSE. The granulometry of these particles can be determined statistically from the distribution function of the equivalent diameter of these particles. Measurement of the granulometry can be performed by any means known to persons specialized in the art, for example by laser diffraction. The following granulometric quantities can be determined from the equivalent diameter distribution function of the particles:
A range of equivalent diameters covering a majority, for example at least 90% in weight, of the particles.
A median of the cumulative granulometric distribution function corresponding to the maximum size of the meshes of a screen enabling a given portion of particles to be fictively separated, for example the median d50 corresponds to the equivalent diameter enabling 50% in weight of the particles to be separated. In other words, the median d50 of the cumulative granulometric distribution function of particles corresponds to the maximum diameter of the fiftieth percentile in weight of said particles.
The number of modes corresponding to the number of equivalent diameter of the distribution function peaks of the particles, each peak being associated with a given quantity of particles.

Advantageously, at least 90% in weight of all the solid particles present a mean equivalent diameter comprised between 0.05 and 5 times the mean diameter of the filaments of the reinforcing fibers and/or at least 90% in weight of the fire-resistant mineral particles CMP present a mean equivalent diameter comprised between 0.05 and 5 times the mean diameter of the filaments of the reinforcing fibers.

Advantageously the median d50 of the cumulative granulometric distribution function corresponding to the fiftieth percentile in weight of the particles is:
on all the solid particles, comprised between 0.2 and 2.0 times the mean diameter of the filaments of the reinforcing fibers, and/or
on the fire-resistant mineral particles CMP only, comprised between 0.1 and 2.0 times the mean diameter of the filaments of the reinforcing fibers.

According to one feature of the invention, the distribution function of the fire-resistant mineral particles CMP is multimodal, for example bimodal, as represented in FIG. 1. Preferably, at least 50% in weight of all the solid particles present an equivalent diameter distribution function comprising at least three modes, and/or at least 50% in weight of the fire-resistant mineral particles CMP present an equivalent diameter distribution function comprising at least two modes. The presence of several modes in particular enables the compactness of the particles to be increased and the dielectric withstand and mechanical strength of the composite composition to be improved.

Preferably, the solid particles, and in particular the fire-resistant mineral particles CMP, have different shapes. The shapes of these particles can be chosen such as to increase the compactness of these particles and to limit the number and/or the size of the cavities in the injection moulded composition. This in particular enables the dielectric withstand and mechanical strength of the injection moulded parts of the composite composition to be improved. The shape of the particles can be characterized by a form factor or by an apparent density, i.e. by a method of weighing a given volume of powder after compaction. In this case, the shape of the fire-resistant solid particles CMP was determined by measuring the apparent density. The apparent density generally depends on the manner in which the particles are compacted. By shaking them, the finest particles insert themselves in the empty spaces between the largest particles. The apparent density can be a compacted apparent density measured according to the standard ASTM B527.

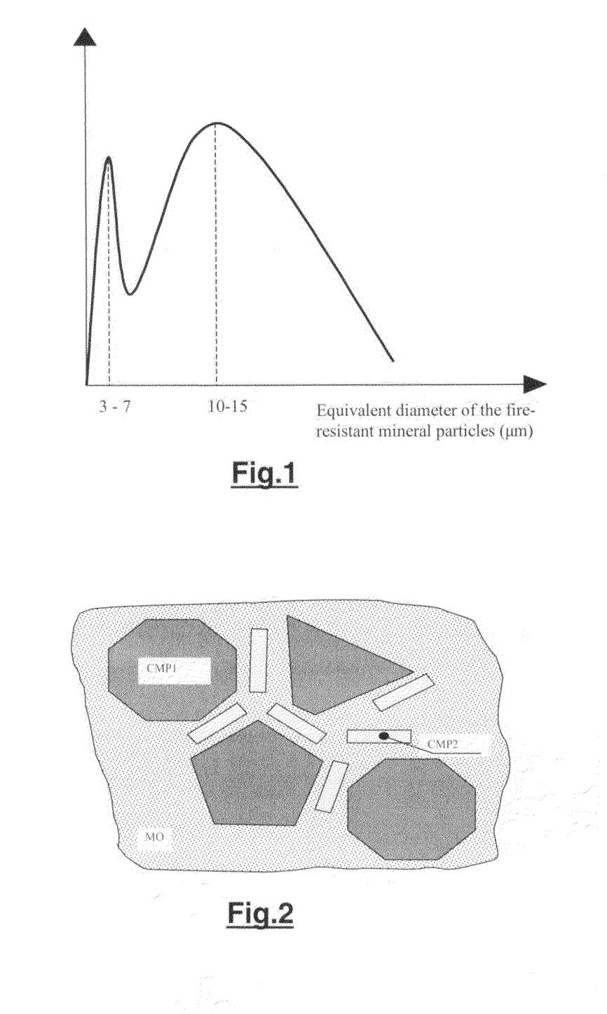

In the example of FIG. 1, about 20 to 40% in weight of the fire-resistant mineral particles CMP present an equivalent diameter situated between 3 and 7 μm CMP2 and about 60 to 80% in weight of the fire-resistant mineral particles present an equivalent diameter situated between 10 and 15 μm CMP1. The fire-resistant solid particles CMP1 and CMP2 are also represented in FIG. 2. The particles CMP2 present an apparent density of about 150 to 250 kg/m3. These particles CMP2 tend to insert themselves between the particles CMP1 which present an apparent density of about 650 to 800 kg/m3. The bimodal shape of the distribution function of the equivalent diameters and the difference of shape between the fire-resistant solid particles CMP1 and CMP2 give the injection moulded composition improved mechanical and dielectric properties.

The solid particles, and in particular the fire-resistant mineral particles CMP2, preferably have a specific surface comprised between 6 and 8 m²/g. The specific surface generally represents the total surface per unit mass of the particles that is accessible to atoms and molecules. The measurement method is based on a process using physical absorption of gas at low temperature and refers to the works of Brunaeur, Emmett and Teller. The specific surface is also called BET surface or BET specific surface. Preferably, the measuring method referenced ISO9277: 1995 is used.

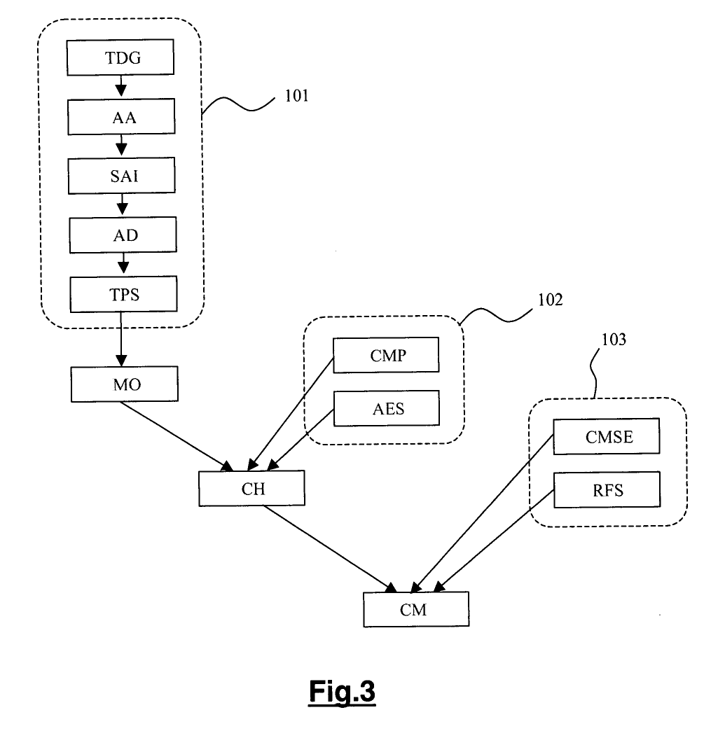

As represented in FIG. 3, the method for preparing 100 parts in weight of a composite composition can for example comprise the following steps:
a preparation step 101 of a first part MO1 of an organic matrix MO by mixing compounds comprising a thermosetting matrix TDG, a thermoplastic additive TPS, a reaction initiating additive AA, an inhibiting additive SAI, and a stripping agent AD,
a step of adding to and mixing a second part MO2 of the organic matrix MO with the first part MO1 of the organic matrix MO, the second part being essentially constituted by a coupling size agent AES together with fire-resistant mineral particles CMP to obtain a homogenized complex mixture CH, and
a step of adding to and mixing at least 5 parts in weight of beads CMSE and from 5 to 15 parts in weight of reinforcing fibers RF with the homogenized complex mixture to obtain a composite composition CMH according to the invention comprising from 15 to 50 parts in weight of the organic matrix.

Adding the coupling size agent AES together with the fire-resistant mineral particles in particular enables physico-chemical forces to be created between the particles and the matrix to optimize coupling of these particles with the matrix.

The specific coupling size agent AES can be added either in pure state or in a mixture. Preferably, the quantity of specific coupling size agent AES added can be comprised between 0.005 and 0.02 times the quantity of fire-resistant mineral particles CMP. The specific coupling size agent AES can be any type of coupling size agent known to those skilled in the art enabling the adherence between the compounds of the mixture to be improved. The specific coupling size agent AES can comprise one or more silanes, for example those comprising functional groups of methacrylate, epoxy, amine, vinyl, ureide, or trimethoxide type. Preferably, the specific coupling size agent AES is taken from the organo-functional silane family. The presence of a specific coupling size agent AES in the composition comprising fire-resistant mineral particles CMP can enable fixing of the silane molecules on the surface of said particles. By their nature, the presence of these molecules enables bonds to be created with the organic matrix, giving the injection moulded composite composition a better mechanical strength.

The step of adding and mixing the beads CMSE and the reinforcing fibers RF can be performed keeping the temperature of the composition at a substantially constant value. Adding of the beads CMSE and reinforcing fibers RF can be progressive, for example with a constant flow rate of about 1 kg per minute. This makes it possible not to start the reticulation reaction of the thermosetting matrix TDG in the mixing apparatuses.

Storing of the composition can be performed by any means known to those skilled in the art. It can be performed in a tightly sealed packaging respecting the usual expiry times and the recommended temperatures, for example of 20° C.+/−3° C.

### COMPARATIVE EXAMPLES

Table 1 below presents two examples of composite compositions, one according to the prior art C1 and the other according to the invention C2.

TABLE 1

| | C1 (Prior art) | C2 (Invention) |
|---|---|---|
| | % weight | % weight |
| Orthophtalic resin (TDG) | 27.835 | 27.835 |
| Tertiobutylperoxy-2-ethyl hexanoate | 0.3 | 0.3 |
| (AA) | | |
| Mixture of ionol and | 0.045 | 0.045 |
| parabenzoquinone (SAI) | | |
| Metallic stearate (AD) | 2 | 2 |
| Thermoplastic (TPS) | 7 | 7 |
| Tri-hydrated alumina (CMP) (*) | 42.4 | 42.4 |
| Organo-functional silanes (AES) | 0.42 | 0.42 |
| Sized spherical mineral charge | 0 | 5 to 10 |
| (CMSE) | | |
| Glass fiber (RF) | 20 | 10 to 15 |

(*) wide granulometric distribution function for C1 (equivalent diameter of the grains comprised between 1 and 80 μm), and specific bimodal granulometric distribution function for C2 (cf. FIG. 1).

Table 2 below presents the relative properties of the injection moulded parts obtained from the composite compositions C1 and C2 presented in table 1.

TABLE 2

| | Relative performance of |
|---|---|
| | C2 compared with C1 |
| Flexional breaking strength | 1.5 |
| ISO 14125 | |
| Charpy impact strength | 1.3 |
| ISO 179 | |
| Elastic energy on multi-axial impact | 2 |
| ISO 6603-2 impact - 10 J | |

Comparatively with the composition C1, the composition C2 provides a clear improvement of the flexional breaking strength and the Charpy impact strength. The improvement of the performance is even more significant as regards the energy absorption on a multi-axial impact. The energy absorbed is in fact twice as great for the composition C2 compared with the composition C1.

Injection moulding of the composition can be performed by any means known to those skilled in the art, for example by means of an industrial press having a capacity of 300 tonnes or more.

The composition according to the invention gives the injection moulded parts an improved mechanical strength and electrical withstand.

Injection moulding of the composition of the invention enables parts to be obtained with a good reproducibility and results in less abrasion of the moulds.

The composition of the invention enables injection moulding of parts with relatively small dimensions to be performed by any injection moulding means known to those skilled in the art, and in particular by means generally implemented for composite compositions comprising more than 15% in weight of reinforcing fibers such as glass fibers.

1. Composite composition for injection moulding comprising:
from 15 to 50% in weight of an organic matrix comprising a thermosetting resin,
reinforcing fibers, and
solid particles comprising fire-resistant mineral particles,
wherein the quantity of reinforcing fibers is comprised between 5 and 15% in weight of said composition, at least a portion of the solid particles greater than 5% in weight of said composition comprises beads, and at least 50% in weight of the fire-resistant mineral particles present a distribution function of the equivalent diameters comprising at least two modes.

2. Composition according to claim 1, wherein the beads have a form factor of less than 2.

3. Composition according to claim 2, wherein the beads have a substantially spherical shape.

4. Composition according to claim 1, wherein the beads are made of glass.

5. Composition according to claim 1, wherein a reinforcing fiber comprises a plurality of filaments.

6. Composition according to claim 5, wherein the beads have a diameter comprised between 0.3 and 5 times the mean diameter of the filaments.

7. Composition according to claim 5, wherein at least 90% in weight of the solid particles present an equivalent diameter comprised between 0.05 and 5 times the mean diameter of the filaments of the reinforcing fibers.

8. Composition according to claim 7, wherein the median of the cumulative granulometric distribution function, corresponding to the fiftieth percentile in weight of the solid particles, is comprised between 0.2 and 20 times the mean diameter of the filaments of the reinforcing fibers.

9. Composition according to claim 7, wherein at least 50% in weight of the solid particles present a distribution function of the equivalent diameters comprising at least three modes.

10. Composition according to claim 5, wherein at least 90% in weight of the fire-resistant mineral particles present a mean equivalent diameter comprised between 0.05 and 5 times the mean diameter of the filaments of the reinforcing fibers.

11. Composition according to claim 8, wherein the median of the cumulative granulometric distribution function, corresponding to the fiftieth percentile in weight of the fire-resistant mineral particles, is comprised between 0.1 and 2.0 times the mean diameter of the filaments of the reinforcing fibers.

12. Composition according to claim 1, wherein the fire-resistant mineral particles are essentially formed by hydrated aluminas.

13. Composition according to claim 1, wherein the fire-resistant mineral particles have different shapes.

14. Composition according to claim 1, wherein the organic matrix comprises a thermoplastic additive.

15. Method for production of 100 parts in weight of a composition by injection moulding comprising:
preparation of at least a part of an organic matrix by mixing compounds comprising a thermosetting resin,
adding and mixing reinforcing fibers, and
adding and mixing solid particles comprising fire-resistant mineral particles,
wherein the quantity of added and mixed reinforcing fibers is comprised between 5 and 15 parts in weight of said composition, a portion of the added and mixed solid particles comprises at least 5 parts in weight of beads, and at least 50% in weight of the fire-resistant mineral particles present a distribution function of the equivalent diameters comprising at least two modes.

16. Method according to claim 15, wherein adding and mixing of the beads and of the reinforcing fibers are performed substantially at the same time.

17. Method according to claim 15, wherein another part of the organic matrix comprising a coupling size agent is added substantially together with the fire-resistant mineral particles.

18. Method according to claim 15, wherein adding and mixing of the beads are performed keeping the temperature of the composition at a substantially constant value.

19. Part obtained by injection moulding of a composition, wherein said composition is a composite composition according to claim 1, the shape of the part being defined by the shape of the mould in which said composition is injected.
